(19) United States
(12) Patent Application Publication
(10) Pub. No.: US 2021/0060745 A1
(43) Pub. Date: Mar. 4, 2021

(54) SEAL INSTALLATION TOOL

(71) Applicant: Parker-Hannifin Corporation, Cleveland, OH (US)

(72) Inventors: Nathan L. Green, Galloway, OH (US); Charles M. Cilensek, Mentor, OH (US); Eric S. Edmiston, Mayfield Heights, OH (US); Otto P. Jantarapet, Westlake, OH (US); Eric A. Salerno, Seven Hills, OH (US)

(21) Appl. No.: 16/984,025

(22) Filed: Aug. 3, 2020

Related U.S. Application Data
(60) Provisional application No. 62/895,030, filed on Sep. 3, 2019.

(51) Int. Cl. B25B 27/00; B25B 27/14

(52) U.S. Cl. CPC B25B 27/0092; B25B 27/14

(57) ABSTRACT

A seal installation tool and method for applying a seal to a component includes a seal-supporting strip in which the seal is retained, a tool body having a through-slot which receives the seal-supporting strip, and a plunger that is supported within the tool body and movable relative to the seal-supporting strip for forcing the seal out of the seal-supporting strip and applying the seal to the component.

### FIELD OF INVENTION

The present invention relates to an assembly tool and method for installing a seal.

### BACKGROUND

Various applications use seals, washers, retaining rings, and similar parts that require installation of the seal part to a component, such as a fluid connector or fitting. Conventional installation or assembly methods include manually applying the seal to the fitting. In some applications, due to the environment in which the seal is being used, the installer may have to wear maintenance gloves which causes decreased dexterity and increased difficulty in handling particularly small seals. Thus, critical sealing surfaces may be dropped or manipulated and damaged during installation. Additionally, the seals may be nested together during transportation of the seals to the location at which the seals are installed. The seals may be difficult to separate from each other and difficult to quickly assemble after arriving at the location. Damage to the seals may result due to the interfacing between the nested seals during transportation and installation.

### SUMMARY OF INVENTION

The present invention is directed toward a seal installation tool and method of applying the seal to a component, such as a fitting. The seal installation tool includes a seal-supporting strip that retains a plurality of seals by an interference fit prior to installation of the seals, a plunger that aligns and forces the seals out of the seal-supporting strip toward the corresponding component, and a tool body that centers the plunger over the component. Using the seal-supporting strip provides support of the seals during transportation of the seals to an installation location and also provides improved handling of the seals during installation. Using the tool body and the plunger also enables improved handling of the seals during installation. The plunger is guided through the tool body and advantageously locates the seal relative to the component to ensure precise alignment of the seal during installation.

According to an aspect of the invention, a seal installation tool for applying a seal to a component includes a seal-supporting strip for retaining the seal, a tool body having a through-slot which receives the seal-supporting strip, and a plunger that is guided through the tool body and movable relative to the seal-supporting strip for aligning the seal relative to the component and forcing the seal out of the seal-supporting strip toward the component.

According to another aspect of the invention, a seal installation assembly includes a seal-supporting strip, a plurality of seals that are retained in the seal-supporting strip, a tool body having a through-slot for receiving the seal-supporting strip, and a plunger that is guided by the tool body and movable relative to the seal-supporting strip for aligning one of the plurality of seals and forcing the seal out of the seal-supporting strip toward a component during installation of the seal. The seal-supporting strip is movable through the through-slot to sequentially align each of the plurality of seals with the plunger for installation of each of the plurality of seals.

According to still another aspect of the invention, a method of installing a seal to a component includes inserting a plurality of seals in a seal-supporting strip, inserting the seal-supporting strip through a through-slot in a tool body, aligning the tool body over a component that receives the seal, moving a plunger through the tool body to force a first seal of the plurality of seals out of the seal-supporting strip to apply the seal to the component, and moving the seal-supporting strip through the through-slot to apply a second seal of the plurality of seals.

Other systems, devices, methods, features, and advantages of the present invention will be or become apparent to one having ordinary skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

FIG. 1 is a drawing depicting a seal installation assembly including a seal installation tool for applying seals to components.

FIG. 2 is a drawing depicting an exploded view of the seal installation assembly of FIG. 1.

FIG. 3 is a drawing depicting a sectional view of the seal installation assembly of FIG. 1 prior to installation of the seal.

FIG. 4 is a drawing depicting a sectional view of the seal installation assembly of FIG. 1 during installation of the seal.

FIG. 5 is a drawing depicting a sectional view of the seal installation assembly of FIG. 1 during installation of one of a plurality of seals being held in a seal-supporting strip of the seal installation assembly.

FIG. 6 is a drawing depicting a sectional view of the seal installation assembly of FIG. 5 during installation of an adjacent seal of the plurality of seals being held in the seal-supporting strip of the seal installation assembly.

### DETAILED DESCRIPTION

The present invention is directed toward a seal installation tool and method of applying a seal to a component. The seal installation tool and method may be used for seals, washers, retaining rings, or any other suitable part that may be applied to another component, such as a fitting, adapter, fluid connector, and other similar components. Using the seal installation tool and method enables both ease in handling the seals and the proper alignment of a seal during installation to the component.

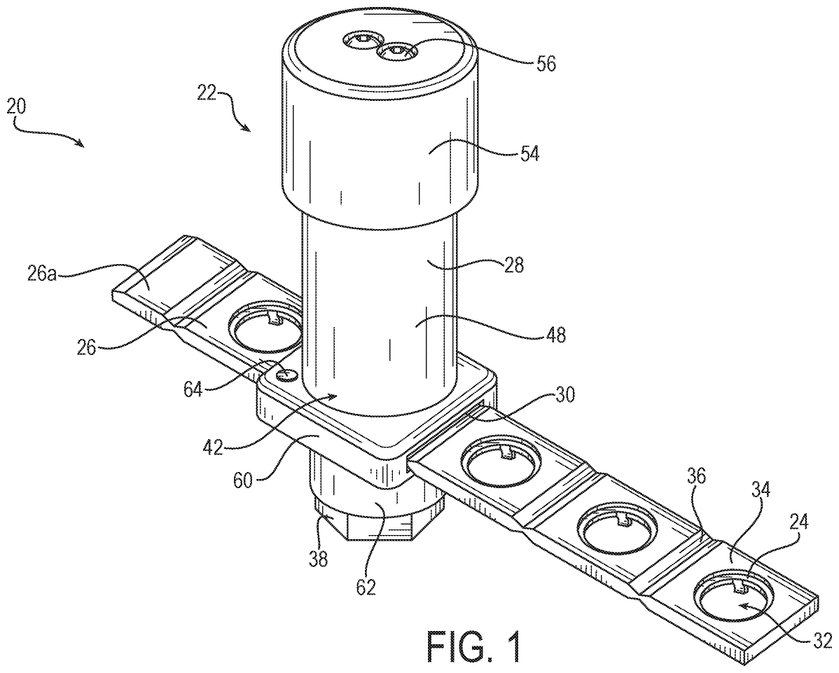

Referring first to FIG. 1, a seal installation assembly 20 having a seal installation tool 22 and at least one seal 24 is shown. The seal installation tool 22 includes a seal-supporting strip 26 and a tool body 28. The tool body 28 defines a through-slot 30 which extends entirely through the tool body 28 and receives the seal-supporting strip 26 such that the seal-supporting strip 26 passes through the through-slot 30. The seal-supporting strip 26 supports and retains the seal 24 or a plurality of seals, e.g. a reel of seals, that are each the same or nearly the same as the seal 24. A recess 32 or a plurality of recesses are defined along an elongated length of the seal-supporting strip 26, and each recess 32 is configured to retain a corresponding seal 24.

The plurality of seals 24 is arranged one seal after another seal along the elongated length of the seal-supporting strip 26, such that the seals 24 may be applied sequentially, or one by one, to a same component or different components. Each recess 32 and corresponding seal 24 may be uniformly sized and equidistantly spaced. The recess 32 is formed to be complementary in shape to the seal 24, and each seal 24 is able to be press-fit into the corresponding recess 32. Each seal 24 is retained within the recess 32 by an interference fit. Each seal 24 may be arranged in the seal-supporting strip 26 during transportation of the seal installation assembly 20 to an installation site and prior to installation of the seal 24. Providing the interference fit between each recess 32 and the seal 24 is advantageous in maintaining a position of the seals 24 within the seal-supporting strip 26 during travel without using any sort of an adhesive that would result in a more difficult removal of the seals 24 from the seal-supporting strip 26 during installation.

The seal-supporting strip 26 has a small thickness and is planar in shape. The width of the seal-supporting strip 26 is significantly less than the total length of the seal-supporting strip 26 and the thickness is less than the width and the length. The seal-supporting strip 26 is formed of any suitable material. Suitable materials may be semi-rigid materials with some flexibility that advantageously enables bending or flexing of the seal-supporting strip 26 during transportation and installation. Exemplary materials that are suitable include thermoplastic polymer materials, such as polypropylene. The seal-supporting strip 26 may include a plurality of planar sections 34 in which the recesses 32 are formed. Each planar section 34 may be connected to an adjacent planar section by a crease or a hinge portion 36 of the material such that the planar sections 34 are flexible and bendable relative to each other. Advantageously, the planar sections 34 may be stacked to fold the seal-supporting strip 26 during transportation while also maintaining each seal 24 separately from the other seals.

Any suitable manufacturing method may be used to form the seal-supporting strip 26, including a 3D printing process, injection molding process, or a combination thereof. Other additive manufacturing processes or molding processes may also be suitable. The seal-supporting strip 26 may be formed to support any suitable seal, including metal or plastic seals. The recesses are sized to accommodate a particular seal, which may be dependent on the application. In exemplary embodiments, the seal-supporting strip 26 may include inserts that are inserted into the recesses to change the diameter of the recesses to accommodate differently sized seals. The seal-supporting strip 26 may be formed with a planar handling section 26a at an end of the seal-supporting strip 26 that does not contain a seal therein and is used to push or pull the seal-supporting strip 26 through the through-slot 30. In other exemplary embodiments, the seal-supporting strip 26 does not include the handling section and the entire length of the seal-supporting strip 26 is used to support seals.

Any one of the seals 24 may be assembled or installed to a component 38, such as a fitting. During installation, the tool body 28 is arranged over the component 38 or directly adjacent the component 38 to align the seal 24 with the component 38. For example, a longitudinal axis of the tool body 28 may be aligned with a longitudinal axis of the component 38. The seal-supporting strip 26 is movable, such as by pushing or pulling, through the through-slot 30 of the tool body 28 to align each planar section 34 with the component 38. Accordingly, the corresponding recess 32 and the seal 24 retained in the recess 32 are aligned with the component 38 when the planar section 34 is positioned or housed within the through-slot 30. Movement of the seal-supporting strip 26 occurs in a direction that is normal to a direction in which force is applied to the seal 24 to force the seal 24 out of the seal-supporting strip 26. The seal-supporting strip 26 may be manually moved or automatically moved through the through-slot 30 to apply each seal 24 in the seal-supporting strip 26 to a component.

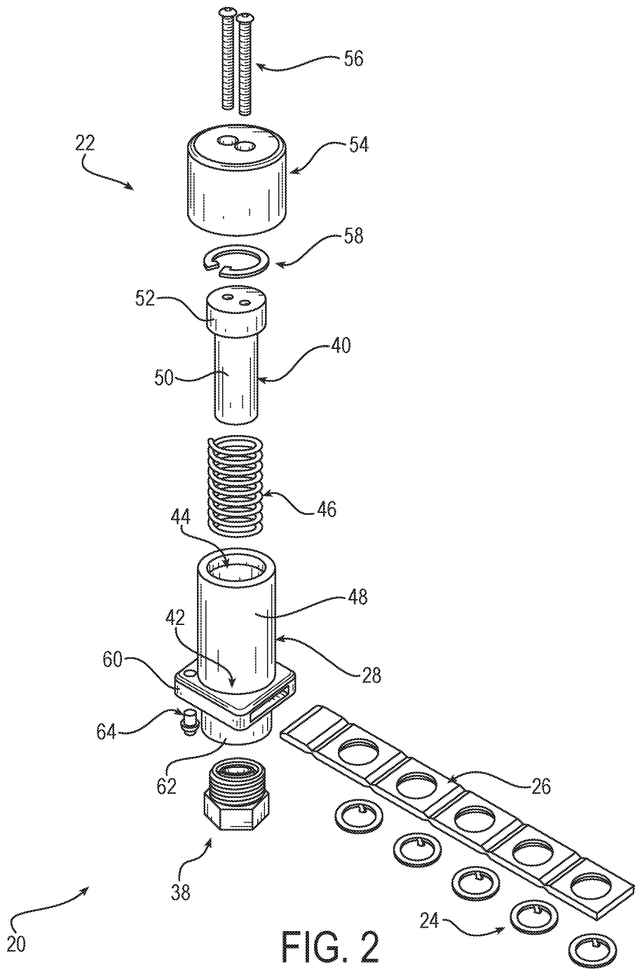

Referring in addition to FIG. 2 which shows an exploded view of the seal installation assembly 20, a plunger 40 is supported by the tool body 28 and used to align and apply the seal 24. The plunger 40 is guided by the tool body 28 for movement toward and away from the seal-supporting strip 26 which is proximate an end 42 of the tool body 28. The tool body 28 is configured to center the plunger 40 over the component 38 when the tool body 28 engages a top of the component 38. The end 42 of the tool body 28 may be a bottom end of the tool body 28 and the plunger 40 may be inserted into an opposite end 44 that may be a top end of the tool body 28. A return spring 46 may also be arranged in the tool body 28 for biasing the plunger 40 to a resting position in which the plunger 40 is moved away from the seal-supporting strip 26. When a force is applied to the plunger 40, such as the manual force from the hand of a user who is installing the seal 24, the plunger 40 overcomes the biasing force of the return spring 46.

The tool body 28 includes a cylindrical housing portion 48 that receives a cylindrical main body 50 of the plunger 40. The cylindrical housing portion 48 of the tool body 28 and the cylindrical main body 50 of the plunger 40 may be arranged along the longitudinal axis of the cylindrical housing portion 48. The plunger 40 includes a flanged portion 52 that is attached to the cylindrical main body 50 and has a diameter that is greater than a diameter of the cylindrical main body 50. The return spring 46 may surround the cylindrical main body 50 and is radially interposed between the cylindrical main body 50 and the cylindrical housing portion 48. The flanged portion 52 may be arranged at a top end of the cylindrical main body 50, and the return spring 46 is engageable against the flanged portion 52 to move the plunger 40 away from the seal-supporting strip 26. The flanged portion 52 and the cylindrical main body 50 may be integrally formed such that the plunger 40 is formed as a single part.

The seal installation tool 22 includes a tool cap 54 that surrounds the opposite end 44 of the tool body 28 and is used to transmit the force from the user's hand to the plunger 40. The tool cap 54 may be cylindrical in shape and has a larger diameter than the diameter of the cylindrical housing portion 48 of the tool body 28 such that the tool cap 54 surrounds the tool body 28 and the plunger 40. Socket head cap screws 56 may be inserted into a top end of the tool cap 54 to fasten the tool cap 54 to the plunger 40. Any number of screws 56 may be suitable. For example, two screws 56 may be used. Other types of screws or fasteners may also be suitable for use instead of the socket head cap screws. The seal installation tool 22 may further include a retaining ring 58 that is arranged to position the return spring 46 under a predetermined preload.

The tool body 28 includes a rectangular housing portion 60 that is arranged adjacent the cylindrical housing portion 48 of the tool body 28 opposite the tool cap 54. The rectangular housing portion 60 defines the through-slot 30. The through-slot 30 extends entirely through the rectangular housing portion 60, and the width of the through-slot 30 may correspond to a width of the seal-supporting strip 26. The width of the through-slot 30 may extend more than half or almost an entire width of the rectangular housing portion 60. The rectangular housing portion 60 and the through-slot 30 extend in a planar direction that is normal to both a direction in which the cylindrical housing portion 48 extends and to the direction of the force and movement of the plunger 40. The rectangular housing portion 60 and the cylindrical housing portion 48 may be formed integrally such that the tool body 28 is formed as a single part. The tool body 28 may further include a component-receiving body 62 that is arranged adjacent the rectangular housing portion 60 opposite the cylindrical housing portion 48 and sized to accommodate a predetermined component 38. The component 38 is received and supported in the component-receiving body 62 during installation of the seal 24. The component-receiving body 62 may be cylindrical in shape and integrally formed with the tool body 28.

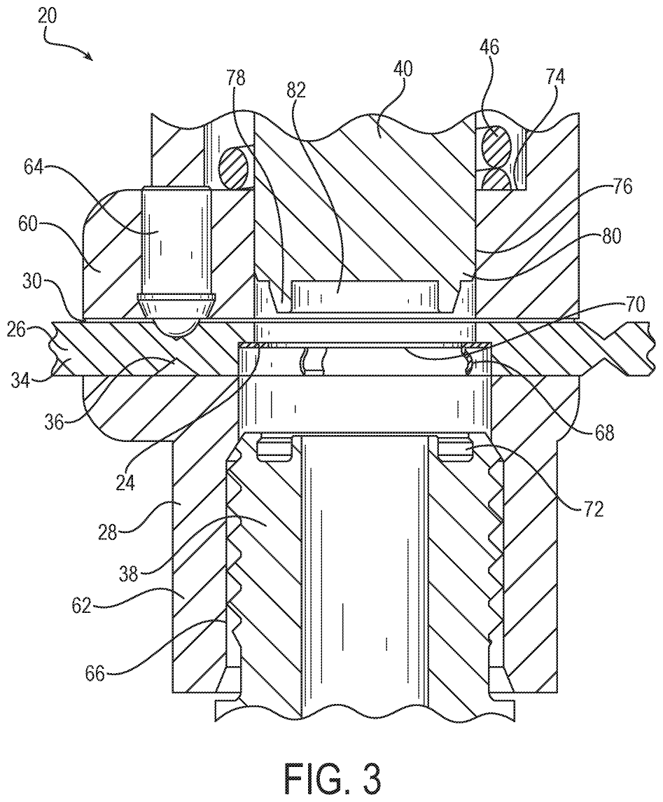

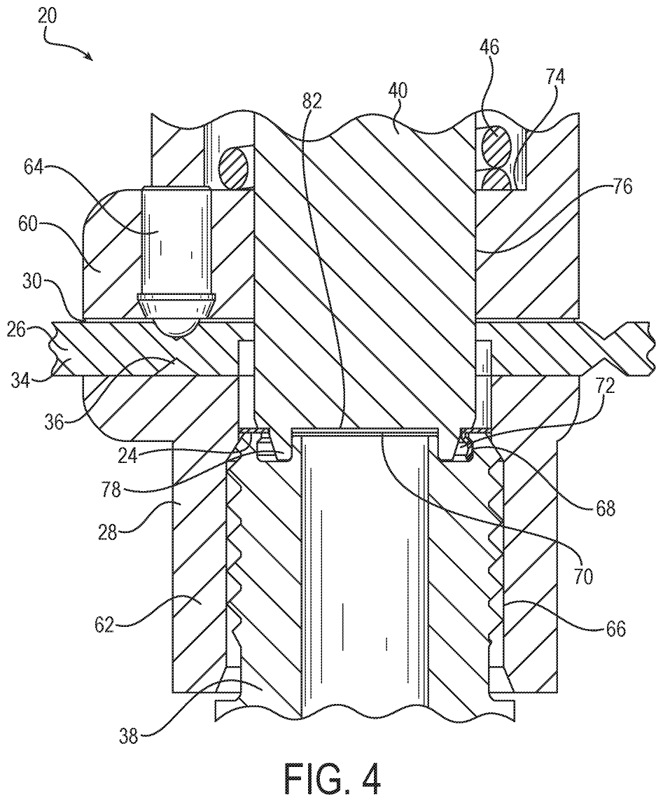

Referring in addition to FIGS. 3 and 4, at least one detent mechanism, such as a ball detent 64, may be provided to hold the seal-supporting strip 26 in place during application of the seal 24 when the seal-supporting strip 26 is inserted to extend through the through-slot 30 defined by the rectangular housing portion 60. The ball detent 64 is arranged on one side of the plunger 40. In other exemplary embodiments, more than one ball detent may be provided. For example, a ball detent may be arranged on two opposite sides of the plunger 40. The ball detent 64 may be inserted into the tool body 28, such as the rectangular housing portion 60, to engage the seal-supporting strip 26 and hold the seal-supporting strip 26 in a fixed position. The seal-supporting strip 26 includes the crease or hinge portion 36 that separates each planar section 34 and is engageable by the ball detent 64 to hold the seal-supporting strip 26 in place.

FIG. 3 shows the seal installation assembly 20 prior to application of the seal 24, and FIG. 4 shows the seal installation assembly 20 during application of the seal 24 to the component 38. The component-receiving body 62 of the tool body 28 is formed to have a recess 66 with a diameter that corresponds to the outer diameter of the component 38 for receiving the component 38. As shown in FIG. 3, the component 38 is inserted into the recess 66 which extends upwardly to the rectangular housing portion 60. The seal-supporting strip 26 is then inserted through the through-slot 30 until the crease or hinge portion 36 is caught by the ball detent 64 to position the planar section 34 and the seal 24 to be applied to the component 38. When the seal-supporting strip 26 is held in place, the plunger 40 and the seal 24 are axially aligned over the component 38.

The seal 24 includes snap fit tabs 68 that project axially outwardly from a main planar body 70 of the seal 24. The snap fit tabs 68 are semi-rigid and configured to engage corresponding notches 72 formed in a top portion of the component 38, as shown in FIG. 4. The rectangular housing portion 60 defines an internal shoulder 74 against which the return spring 46 engages, and an internal diameter 76 which aligns the plunger 40 during travel of the plunger 40 through the tool body 28. When the force is applied to overcome the force of the return spring 46, the plunger 40 is pushed toward the seal 24. The tool body 28 and the plunger 40 may be formed to enable linear movement of the plunger 40 that is directly normal relative to the seal 24 such that the plunger 40 applies a maximum amount of axial force to the seal 24 ensuring that the seal 24 is forced out of the seal-supporting strip 26.

The plunger 40 includes protrusions 78 that axially extend from a tip end 80 of the plunger 40 and reach into the notches 72 of the component 38. The protrusions 78 may have any suitable shape, and the shape may be formed to engage the seal 24 and latch at a particular location of the seal 24 to locate and center the seal 24 relative to the component 38. For example, the protrusions 78 may have a tapered shape. An axial recessed portion 82 may be defined between the protrusions 78. The plunger 40 may have any suitable geometry that enables the plunger 40 to precisely engage and apply the seal 24 to the component. The geometry may be dependent on the geometry of the seals and the components to which the seals are being applied. For example, the plunger 40 may be sized for a fitting having any diameter size, such as half an inch or greater.

When the plunger 40 is forced downwardly toward the seal 24 to apply the seal 24, the plunger 40 is guided by the internal diameter 76 of the rectangular housing portion 60 of the tool body 28. The protrusions 78 engage the seal 24 within the seal-supporting strip 26 to slightly deform the seal 24 and push the seal 24 downwardly out of the seal-supporting strip 26 that is held in the rectangular housing portion 60 by the ball detent 64. The protrusions 78 are engageable in the notches 72 such that the protrusions 78 locate the seal 24 and ensure that the snap fit tabs 68 of the seal 24 engage into the notches 72 of the component 38. The snap fit tabs 68 may be semi-rigid and flexible to slightly contract during insertion of the snap fit tabs 68 into the notches 72. When the snap fit tabs 68 are in the notches 72, they may retract to secure the seal 24 against the component 38, as shown in FIG. 4. The main planar body 70 of the seal 24 may be received in the axial recessed portion 82 of the plunger 40.

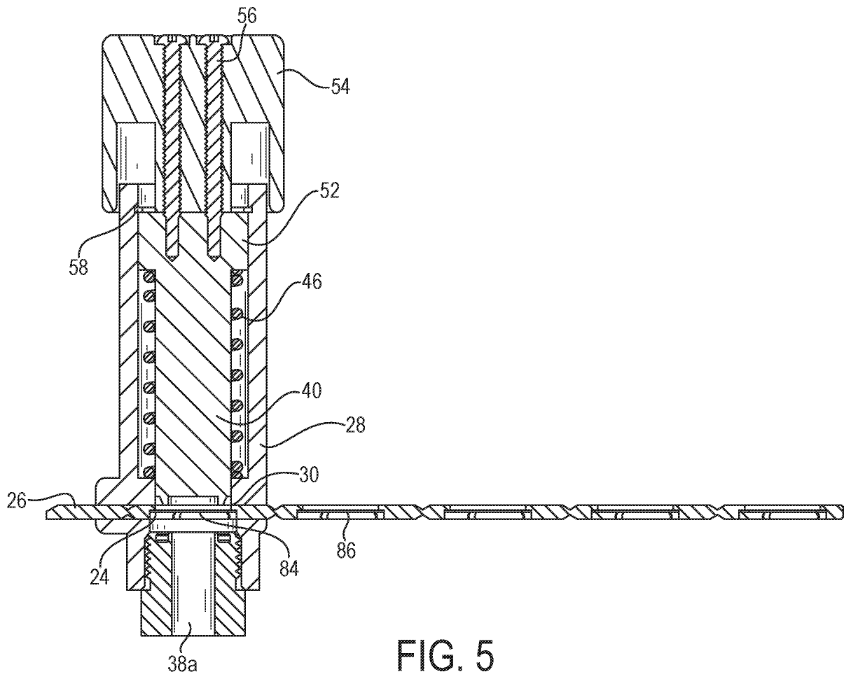

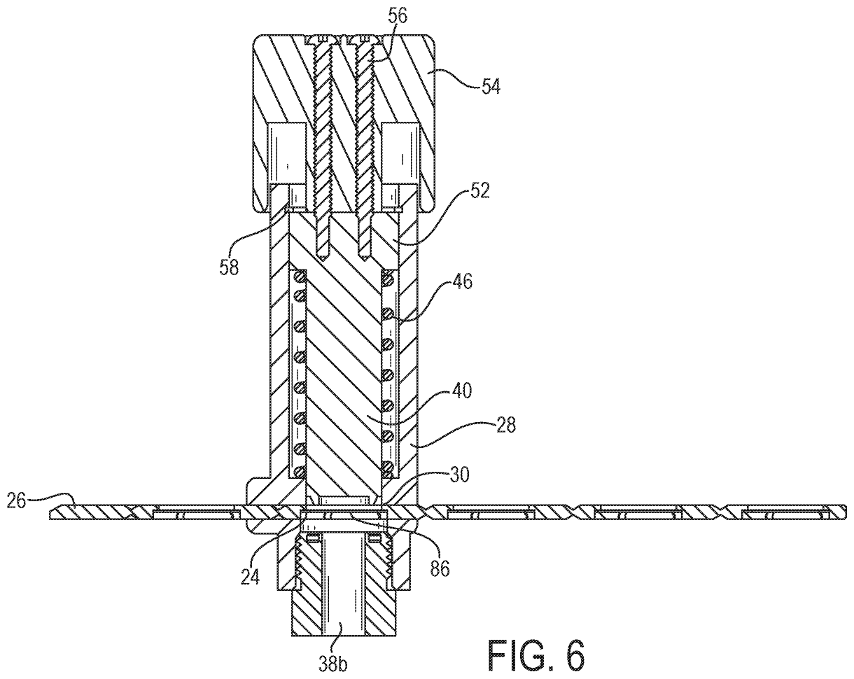

Referring in addition to FIGS. 5 and 6, after the seal 24 is installed to the component 38 and force is no longer being applied against the plunger 40, the force of the return spring 46 acts against the flanged portion 52 of the plunger 40 to force the plunger 40 upwardly away from the seal-supporting strip 26. FIGS. 5 and 6 also show the tool cap 54 being secured to the plunger 40 by the socket head cap screws 56, and the retaining ring 58 arranged proximate the plunger 40 to position the return spring 46. FIG. 5 shows a first seal 84 of the reel of seals 24 prior to the seal 84 being applied to the component 38a. FIG. 6 shows the seal-supporting strip 26 after being moved by through the through-slot 30 of the tool body 28 from the first seal 84 to the second seal 86 for application of the second seal 86 to the component 38b. The component 38b may be the same component 38a as in FIG. 5 such that two seals are applied to the same component, or the component 38b may be a separate component. Movement of the seal-supporting strip 26 through the through-slot 30 may be performed manually, such as by the user pushing or pulling the seal-supporting strip 26, or the movement may be automated by any suitable machine. In exemplary embodiments, the automated movement may include a predetermined interval for sequentially applying each seal one by one.

A seal installation tool for applying a seal to a component includes a seal-supporting strip for retaining the seal, a tool body having a through-slot which receives the seal-supporting strip, and a plunger that is guided through the tool body and movable relative to the seal-supporting strip for aligning the seal relative to the component and forcing the seal out of the seal-supporting strip toward the component.

The seal installation tool may include at least one ball detent that is arranged in the tool body and engageable against the seal-supporting strip for holding the seal supporting strip in the tool body.

The seal installation tool may include a return spring that biases the plunger away from the seal-supporting strip.

The seal installation tool may include a retaining ring for positioning the return spring.

The plunger may extend in a direction normal to a direction in which the seal-supporting strip is elongated.

The seal-supporting strip may hold the seal with an interference fit.

The seal-supporting strip may be formed of a flexible material.

The seal-supporting strip may define a plurality of seal-supporting recesses for supporting a plurality of seals.

The plurality of seal-supporting recesses may be equidistantly spaced along a length of the seal-supporting strip.

The plunger may have a tip end with axially spaced protrusions and a recessed area defined between the protrusions.

The tool body may include a cylindrical housing portion that supports the plunger and a rectangular housing portion that defines the through-slot.

A longitudinal axis of the cylindrical housing portion may extend perpendicular to a plane in which the rectangular housing portion and the through-slot extend.

The cylindrical housing portion and the rectangular housing portion may be integrally formed.

The seal installation tool may include a tool cap that is engageable with the plunger for transmitting an applied force to the plunger.

The seal installation tool may include at least one socket head cap screw for fastening the tool cap to the plunger.

A seal installation assembly includes a seal-supporting strip, a plurality of seals that are retained in the seal-supporting strip, a tool body having a through-slot for receiving the seal-supporting strip, and a plunger that is guided through the tool body and movable relative to the seal-supporting strip for aligning one of the plurality of seals and forcing the seal out of the seal-supporting strip toward a component during installation of the seal. The seal-supporting strip is movable through the through-slot to sequentially align each of the plurality of seals with the plunger for installation of each of the plurality of seals.

The seal installation assembly may include at least one ball detent that is arranged in the tool body and engageable against the seal-supporting strip for holding the seal supporting strip relative to the tool body when one of the plurality of seals is being applied.

The seal installation assembly may include a return spring that biases the plunger away from the seal-supporting strip.

The seal installation assembly may include a retaining ring for positioning the return spring.

The plunger may extend in a direction normal to a direction in which the seal-supporting strip is elongated.

The seal-supporting strip may support each of the plurality of seals with an interference fit.

The seal-supporting strip may be formed of a flexible material.

The seal-supporting strip may define a plurality of seal-supporting recesses for supporting the plurality of seals, with the plurality of seal-supporting recesses being equidistantly spaced along a length of the seal-supporting strip.

The plunger may have a tip end with axially spaced protrusions and a recessed area defined between the protrusions.

The protrusions may engage the seal being applied to the component to deform the seal.

Each of the plurality of seals may have snap-fit tabs for securing the seal to the component.

The tool body may include a cylindrical housing portion that supports the plunger and a rectangular housing portion that defines the through-slot.

A longitudinal axis of the cylindrical housing portion may extend perpendicular to a plane in which the rectangular housing portion and the through-slot extend.

The cylindrical housing portion and the rectangular housing portion may be integrally formed.

The seal installation assembly may include a tool cap that is engageable with the plunger for transmitting an applied force to the plunger.

The seal installation assembly may include at least one socket head cap screw for fastening the tool cap to the plunger.

A method of installing a seal to a component includes inserting a plurality of seals in a seal-supporting strip, inserting the seal-supporting strip through a through-slot in a tool body, aligning the tool body over a component that receives the seal, moving a plunger through the tool body to force a first seal of the plurality of seals out of the seal-supporting strip to apply the seal to the component, and moving the seal-supporting strip through the through-slot to apply a second seal of the plurality of seals.

The method may include forming the seal-supporting strip using additive manufacturing.

The method may include aligning the first seal with the component using the plunger.

The method may include applying a force to the plunger that is normal to a direction in which the seal-supporting strip is elongated.

The method may include automatically moving the seal-supporting strip through the through-slot for continuously applying the plurality of seals. The method may include press-fitting the plurality of seals in the seal-supporting strip.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A seal installation tool for applying a seal to a component, the seal installation tool comprising:
a seal-supporting strip for retaining the seal;
a tool body having a through-slot which receives the seal-supporting strip; and
a plunger that is guided through the tool body and movable relative to the seal-supporting strip for aligning the seal relative to the component and forcing the seal out of the seal-supporting strip toward the component.

2. The seal installation tool according to claim 1 further comprising at least one ball detent that is arranged in the tool body and engageable against the seal-supporting strip for holding the seal supporting strip in the tool body.

3. The seal installation tool according to claim 1 further comprising a return spring that biases the plunger away from the seal-supporting strip.

4. The seal installation tool according to claim 3 further comprising a retaining ring for positioning the return spring.

5. The seal installation tool according to claim 1, wherein the plunger extends in a direction normal to a direction in which the seal-supporting strip is elongated.

6. The seal installation tool according to claim 1, wherein the seal-supporting strip holds the seal with an interference fit.

7. The seal installation tool according to claim 1, wherein the seal-supporting strip is formed of a flexible material.

8. seal installation tool according to claim 1, wherein the seal-supporting strip defines a plurality of seal-supporting recesses for supporting a plurality of seals.

9. The seal installation tool according to claim 8, wherein the plurality of seal-supporting recesses are equidistantly spaced along a length of the seal-supporting strip.

10. The seal installation tool according to claim 1, wherein the plunger has a tip end with axially spaced protrusions and a recessed area defined between the protrusions.

11. The seal installation tool according to claim 1 wherein the tool body includes a cylindrical housing portion that supports the plunger and a rectangular housing portion that defines the through-slot.

12. The seal installation tool according to claim 11, wherein a longitudinal axis of the cylindrical housing portion extends perpendicular to a plane in which the rectangular housing portion and the through-slot extend.

13. The seal installation tool according to claim 11, wherein the cylindrical housing portion and the rectangular housing portion are integrally formed.

14. The seal installation tool according to claim 1 further comprising a tool cap that is engageable with the plunger for transmitting an applied force to the plunger.

15. The seal installation tool according to claim 14 further comprising at least one socket head cap screw for fastening the tool cap to the plunger.

16. A seal installation assembly comprising:
a seal-supporting strip;
a plurality of seals that are retained in the seal-supporting strip;
a tool body having a through-slot for receiving the seal-supporting strip; and
a plunger that is guided through the tool body and movable relative to the seal-supporting strip for aligning one of the plurality of seals and forcing the seal out of the seal-supporting strip toward a component during installation of the seal,
wherein the seal-supporting strip is movable through the through-slot to sequentially align each of the plurality of seals with the plunger for installation of each of the plurality of seals.

17. The seal installation assembly according to claim 16 further comprising at least one ball detent that is arranged in the tool body and engageable against the seal-supporting strip for holding the seal supporting strip relative to the tool body when one of the plurality of seals is being applied, a return spring that biases the plunger away from the seal-supporting strip, and a retaining ring for positioning the return spring.

18-20. (canceled)

21. The seal installation assembly according to claim 16, wherein the seal-supporting strip is formed of a flexible material and supports each of the plurality of seals with an interference fit, the seal-supporting strip defining a plurality of seal-supporting recesses that are equidistantly spaced along a length of the seal-supporting strip.

22-25. (canceled)

26. The seal installation assembly according to claim 16, wherein each of the plurality of seals has snap-fit tabs for securing the seal to the component.

27-31. (canceled)

32. A method of installing a seal to a component, the method comprising:
forming the seal-supporting strip using additive manufacturing;
press-fitting a plurality of seals in the seal-supporting strip;
inserting the seal-supporting strip through a through-slot in a tool body;
aligning the tool body over a component that receives the seal;
moving a plunger through the tool body to force a first seal of the plurality of seals out of the seal-supporting strip to apply the seal to the component; and
moving the seal-supporting strip through the through-slot to apply a second seal of the plurality of seals.

33-37. (canceled)
